(19) United States
(12) Patent Application Publication
(10) Pub. No.: US 2022/0289525 A1
(43) Pub. Date: Sep. 15, 2022

(54) PASSENGER CONVEYOR SYSTEM

(71) Applicant: Innova Patent GmbH, Wolfurt (AT)

(72) Inventors: Pavel Vlasak, Sarnthein (IT); Zdenek Gremlica, Most (CZ); Jiri Drencko, Most (CZ)

(21) Appl. No.: 17/639,655

(22) PCT Filed: Aug. 31, 2020
(86) PCT No.: PCT/EP2020/074194

§ 371 Date: Mar. 2, 2022

(30) Foreign Application Priority Data
Sep. 2, 2019 (AT) A 50764/2019

(51) Int. Cl. B66B 21/10; B66B 23/24; B66B 29/08

(52) U.S. Cl. CPC B66B 21/10; B66B 23/24; B66B 29/08

(57) ABSTRACT

A passenger conveyor system has a conveyor belt with a longitudinal extension in the conveying direction and a balustrade on at least one side of the conveyor belt. At least sections of the balustrade extend laterally adjacent the conveyor belt. The balustrade has at least two balustrade sections. At least one opening for entering and leaving the conveyor belt is located between two successive balustrade sections of the balustrade laterally adjacent the conveyor belt.

The invention relates to a passenger conveyor device, comprising a conveyor belt with a longitudinal extent in the conveying direction and a balustrade on at least one side of the conveyor belt, the balustrade running, at least in sections, laterally next to the conveyor belt.

For persons who are traveling on foot and are possibly carrying luggage items or shopping, there are passenger conveyor devices, for example in airports, at railway stations, in malls or in exhibition halls, which passenger conveyor devices are also called moving walkways, by way of which horizontal distances can be covered more easily and/or more rapidly.

The conveyor belt of passenger conveyor devices of this type as a rule runs in a straight line, with balustrades with handrails arranged on both sides of the conveyor belt and an entry region only at the start and an exit region only at the end of the passenger conveyor device. One part of the conveyor belt, on which persons can stand or walk, runs on the upper side, while the other part of the conveyor belt is returned below the first part in the opposite direction.

WO 2012/097390 A1 has disclosed a passenger conveyor device, the conveyor belt of which, unlike in the case of conventional passenger conveyor devices, runs in a substantially horizontally oriented, closed loop, with the result that the passenger conveyor device does not have a defined start or a defined end. In the case of this passenger conveyor device, the balustrade is attached only on one side in order to make entry and exit possible. However, this means that the supporting and/or protecting function of the balustrade is dispensed with on the other side.

The invention is based on the object of providing a passenger conveyor device of the generic type mentioned at the outset which does not have the disadvantages of the prior art.

According to the invention, this object is achieved by way of a passenger conveyor device which has the features of claim 1.

Preferred and advantageous embodiments of the invention are the subject matter of the subclaims.

It is provided according to the invention that the balustrade has at least two balustrade sections, and that at least one opening for stepping onto and stepping off the conveyor belt is arranged between two successive balustrade sections of the balustrade laterally next to the conveyor belt.

The balustrade is preferably high enough for it to reach approximately as far as the hip of an adult of average size, with the result that passengers using the passenger conveyor device can support themselves thereon. The balustrade according to the invention affords substantially all the advantages of the balustrades known from the prior art, apart from the opening/openings for stepping onto and stepping off the conveyor belt.

Persons can be transported in a horizontal direction by way of the conveyor belt of the passenger conveyor device according to the invention. Simultaneous transporting of the persons in the vertical direction is not necessarily provided, but is also not ruled out. Passenger conveyor devices according to the invention are, for example, passenger conveyor devices which run substantially in one plane, but also passenger conveyor devices which overcome, at least in sections, a certain gradient, up to, for example, 12° (corresponds to a gradient of approximately 20.8%). For example, the passenger conveyor device according to the invention can be a plate conveyor.

It is also possible within the context of the invention, however, that the passenger conveyor device is an escalator which spans a gradient of more than 12%, for example of from 25% to 40%, in particular of approximately 30%, or has sections in the form of an escalator in conjunction with horizontal or merely slightly inclined sections.

In particular, the opening of the passenger conveyor device according to the invention is delimited by way of balustrade ends on the balustrade sections. The balustrade sections with the balustrade ends are arranged successively or behind one another as viewed in the direction of the longitudinal extent.

The passenger conveyor device according to the invention preferably has two balustrades which run, at least in sections, on both sides of the conveyor belt, it being possible for either only one or both balustrades to have one or more openings. Embodiments in the case of which the conveyor belt is delimited only on one side by a balustrade are also conceivable. In the case of embodiments of this type, for example a wall or no delimiting means is arranged on the other side of the conveyor belt.

Embodiments in the case of which a substantially vertical bar which protrudes upward beyond the balustrade is arranged at at least one of the two balustrade ends of the balustrade sections between which the opening is formed are preferred. A bar of this type, if it is arranged at the front balustrade end of the opening as viewed in the conveying direction of the passenger conveyor device, can be gripped by a person stepping onto the conveyor belt and serves as a support or pivot point during the change in the direction of movement of this person that occurs when stepping onto the conveyor belt. If a bar of this type is arranged at the rear balustrade end of the opening as viewed in the conveying direction, it can be utilized in a corresponding way when stepping off the conveyor belt.

Bars of this type are preferably arranged on/at the two balustrade sections or balustrade ends of the opening, with the result that persons stepping onto the conveyor belt and also persons stepping off the conveyor belt can use it.

Within the context of the invention, an embodiment in the case of which a guide element is arranged on at least one of the two successive balustrade sections between which the opening is formed, which guide element runs obliquely away from the conveyor belt, and, with the adjoining balustrade section, encloses an angle of from >90° to 160°, in particular of between 100° and 135°, preferably of approximately 110°, is preferred, in particular. A guide element of this type forces persons stepping onto or stepping off the conveyor belt to do this within a certain angle range between the conveyor belt and the guide element. The risk of persons experiencing an excessively abrupt change of direction of movement and possibly falling over when stepping off or when stepping on is decreased as a result.

The guide element or the guide elements is/are arranged in the region of the balustrade end or the balustrade ends, in particular directly adjoining the balustrade end or ends. The guide element further preferably adjoins the respective balustrade section at the level of an upper edge of the latter.

The guide element or the guide elements preferably has/have the form of a U-shaped hoop, the limb ends of which are arranged on the balustrade section, in particular at the balustrade end. If a bar, as has already been described, is arranged at the balustrade end, the guide element can be connected to the bar.

Within the context of the invention, the guide element is particularly preferably arranged on the rear balustrade section which delimits the opening, in particular at the balustrade end of said balustrade section. It can also be arranged, however, on the front balustrade section which delimits the opening, in particular at the balustrade end of said balustrade section. It is also possible, if also not preferred, that guide elements are arranged on the two balustrade sections which delimit the opening, in particular at the balustrade ends of said balustrade sections.

If the guide element is arranged on the rear balustrade section (as viewed in the conveying direction of the passenger conveyor device) which delimits the opening, in particular at the balustrade end of said balustrade section, the guide element assists persons while stepping off the conveyor belt. In addition, a guide element of this type makes it difficult to step onto the conveyor belt counter to the conveying direction, with the result that careless persons are less at risk of falling over.

If it is arranged on the front balustrade section (as viewed in the conveying direction of the passenger conveyor device) which delimits the opening, in particular at the balustrade end of said balustrade section, the guide element assists persons while stepping onto the conveyor belt, in a corresponding way.

Within the context of the invention, guide elements can also be arranged on the two balustrade sections between which the opening is formed. In the case of an embodiment of this type, the guide elements preferably enclose the same angle or different angles with the respective adjoining balustrade section. Within the context of the invention, the angles can likewise have a magnitude of from >90° to 160°, in particular of from 100° to 135°, preferably of approximately 110°. As an alternative to this, even if it is not preferred, one of the angles can have a magnitude of from 20° to <90°, in particular of from 45° to 80°, preferably of approximately 70°.

It is preferred if the passenger conveyor device has a further balustrade on the other side of the conveyor belt. A handrail is particularly preferably guided along an upper edge of the further balustrade. Persons using the conveyor belt can support themselves, while traveling, on the handrail, which, in particular, moves at the same speed in the same direction as the conveyor belt.

It can be provided within the context of the invention that the conveyor belt is arranged at an elevated level with respect to the adjoining ground next to the conveyor device, and that a platform runs along the opening. The platform preferably lies at the same level as the conveyor belt.

The conveyor belt and the balustrade or balustrades can also be arranged on a base. Even with a base, the platform preferably lies at the same level as the conveyor belt, but can also lie at a lower level, with the result that a small step is formed.

The platform avoids an excessively large step being formed directly between the conveyor belt and the adjoining ground next to the conveyor device, over which excessively large step a person might stumble immediately on stepping off or stepping onto the conveyor belt.

In a further embodiment, a handrail is arranged on one or both balustrade sections, the forward-running strip of which handrail, guided on the upper edge of the balustrade, runs downward at the balustrade end to form a returning strip, which is guided at the bottom on the balustrade. Handrails of this type afford persons the possibility, while traveling on the conveyor belt, of also supporting themselves on the balustrade which has the opening. The regions at the balustrade ends in which the strips of the handrails run downward and upward are preferably encased by covering elements.

The passenger conveyor device according to the invention can preferably have the features of the conveyor devices described in WO 2012/097390 A1, WO 2016/205839 A1 or WO 2017/044996 A1.

In particular, the conveyor belt can have curved and straight track sections, the opening preferably being arranged in a straight track section.

Further details, features and advantages of the invention result from the following description with reference to the appended drawings, in which preferred embodiments are shown and in which:

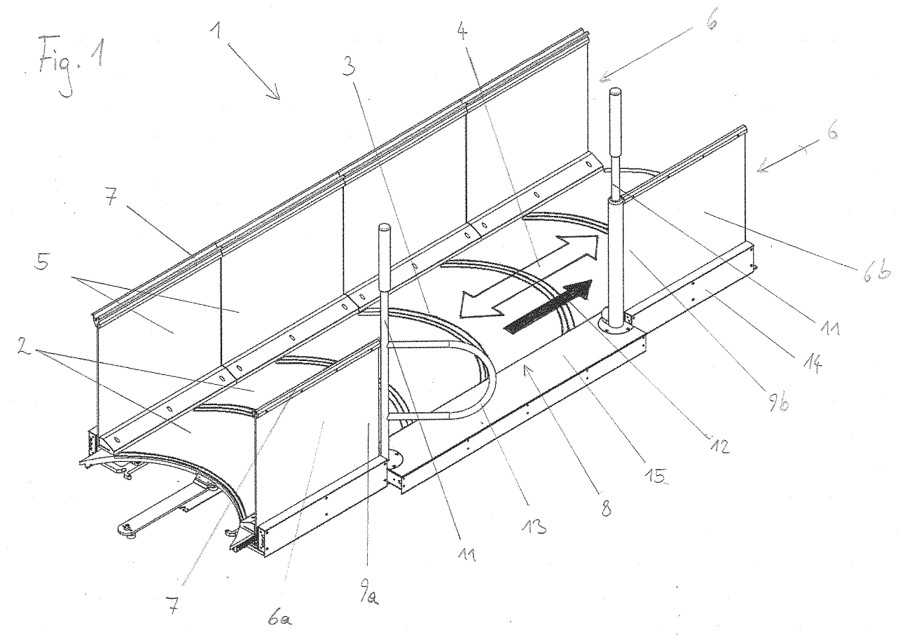

FIG. 1 shows an isometric view of a section of a passenger conveyor device according to the invention, and

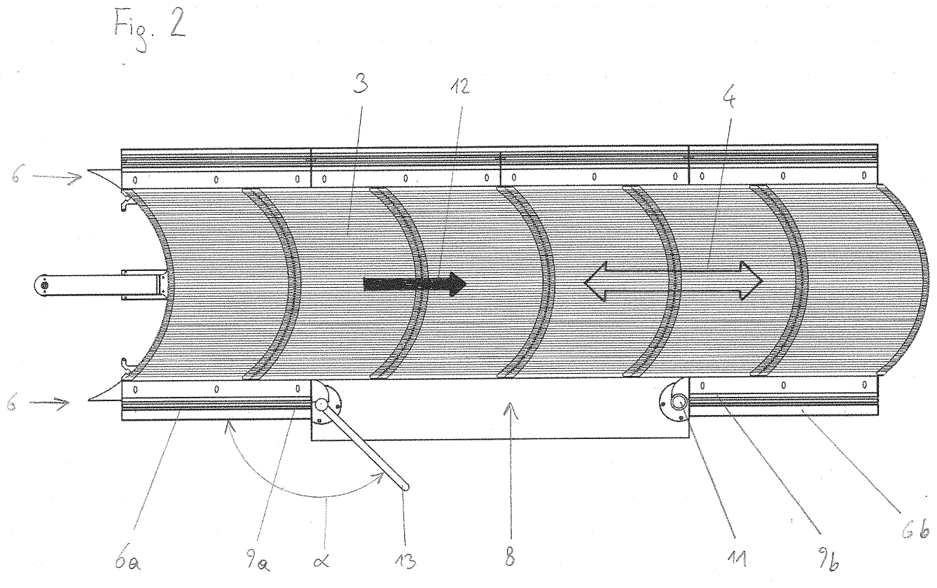

FIG. 2 shows a plan view of the section of the passenger conveyor device according to the invention.

FIG. 1 shows a section of a passenger conveyor device 1 according to the invention with a conveyor belt 3 which is assembled from a multiplicity of segments 2. The conveyor belt 3 and the passenger conveyor device 1 run along a longitudinal extent 4 in the conveying direction 12.

On both sides along the conveyor belt 3, the passenger conveyor device 1 has balustrades 6, which are in each case assembled from plate-shaped elements 5. An upper edge 7 of the balustrades 6 lies approximately at the hip height of an adult person of average size.

One of the balustrades 6 has an opening 8 which is formed between balustrade ends 9a, 9b of two balustrade sections 6a, 6b and extends over the entire height of the balustrade 6, that is to say from the conveyor belt 3 to the upper edge 7 of the balustrade 6. Persons can step onto or step off the conveyor belt 3 to the side through the opening 8.

A handrail which can be displaced in the conveying direction 12 can be arranged on the upper edge 7 of at least one of the balustrades 6, in particular on the left-hand (in the conveying direction 12 in FIG. 2) balustrade 6, which does not have an opening 8.

A bar 11 which protrudes vertically beyond the upper edge 7 of the balustrade 6 is arranged at each of the balustrade ends 9a, 9b.

A guide element 13 in the form of a U-shaped hoop is arranged on the bar 11 on the rear (as viewed in the conveying direction 12) balustrade section 6a or at the balustrade end 9a of said balustrade section 6a. The guide element 13 runs obliquely away from the conveyor belt 3 and in the direction of the other balustrade section 6b which delimits the opening 8, or the balustrade end 9b of said balustrade section 6a. The upper limb of the hoop lies approximately at the level of the upper edge 7 of the balustrade section 6b.

In the embodiment which is shown, the bars 11 are padded in an upper region. In addition to this, the front (as viewed in the conveying direction 12) bar 11 is padded in a region of the balustrade end 9b. Within the context of the invention, however, the bars 11 can also be padded in other regions or not at all.

The conveyor belt 3 and the balustrades 6 are arranged at an elevated level on a base 14. A platform 15 which is arranged to the side of the balustrade 6 runs along the opening 8 and substantially at the same level as the conveyor belt 3. As a result, a step is formed between the platform 15 and the adjoining ground next to the conveyor device, which step is remote from the conveyor belt 3, affording persons the possibility of separating the time of stepping onto and stepping off the conveyor belt 3 from that of crossing the step.

FIG. 2 shows the passenger conveyor device 1 according to the invention in a plan view, only a section of the passenger conveyor device 1 being shown, as in FIG. 1.

The balustrade 6 which is arranged at the bottom in FIG. 2 has an opening 8 which runs between the two balustrade sections 6a, 6b, in particular between the balustrade ends 9a, 9b of said balustrade sections 6a, 6b, and through which it is possible to step onto and to step off the conveyor belt 3.

The guide element 13 is arranged at the rear (as viewed in the conveying direction 12) balustrade end 9a and encloses an angle α with the adjoining balustrade section 6a. In

FIG. 2, the angle α has a magnitude of approximately 135°, with the result that the guide element 13 is directed away from the conveyor belt 3 at an angle of approximately 45°.

As shown in FIG. 2, the segments 2 of the conveyor belt 3 can have ribs on their surface. The segments 2 can also be of smooth configuration, however.

### LIST OF DESIGNATIONS

1 Passenger conveyor device

2 Segment

3 Conveyor belt

4 Longitudinal extent

5 Plate-shaped element

6 Balustrade

6a/6b Balustrade section

7 Upper edge

8 Opening

9a/9b Balustrade end

10

11 Bar

12 Conveying direction

13 Guide element

14 Base

15 Platform

1-13. (canceled)

14. A passenger conveyor device, comprising:
a conveyor belt extending along a longitudinal extent in a conveying direction;
a balustrade laterally on at least one side of said conveyor belt, said balustrade running, at least in sections, laterally adjacent said conveyor belt;
said balustrade having at least two balustrade sections and at least one opening formed between two successive balustrade sections laterally next to said conveyor belt for stepping onto and stepping off said conveyor belt.

15. The passenger conveyor device according to claim 14, wherein said opening is delimited by balustrade ends on said at least two balustrade sections.

16. The passenger conveyor device according to claim 15, further comprising a substantially vertical rod protruding upward beyond said balustrade arranged at one of said balustrade ends.

17. The passenger conveyor device according to claim 15, further comprising a substantially vertical rod protruding upward beyond said balustrade ends at each of said two balustrade ends.

18. The passenger conveyor device according to claim 14, further comprising a guide element arranged on the respective balustrade section that lies in front of said opening in the conveying direction, said guide element running in a direction toward said opening and obliquely away from said conveyor belt, and enclosing an angle from >90° to 160° with said respective balustrade section.

19. The passenger conveyor device according to claim 18, the angle between said respective balustrade section and said guide element lies between 100° and 135°.

20. The passenger conveyor device according to claim 18, the angle between said respective balustrade section and said guide element lies between 105° and 120°.

21. The passenger conveyor device according to claim 18, wherein said opening is delimited by balustrade ends on said at least two balustrade sections and said guide element is arranged at a balustrade end of the respective balustrade section that lies in front of said opening in the conveying direction.

22. The passenger conveyor device according to claim 21, wherein said guide element is arranged directly at said balustrade end of the respective balustrade section that lies in front of said opening in the conveying direction.

23. The passenger conveyor device according to claim 18, which comprises a further guide element arranged on the respective balustrade section being a forward balustrade section that lies behind the opening in the conveying direction, said further guide element extending in a direction toward said opening and obliquely away from said conveyor belt, and enclosing an angle of from >90° to 160° with said forward balustrade section.

24. The passenger conveyor device according to claim 23, the angle between said forward balustrade section and said further guide element lies between 100° and 135°.

25. The passenger conveyor device according to claim 23, the angle between said forward balustrade section and said further guide element lies between 105° and 120°.

26. The passenger conveyor device according to claim 25, wherein said further guide element is arranged in a region of a balustrade end of said forward balustrade section that lies behind said opening.

27. The passenger conveyor device according to claim 26, wherein said further guide element is arranged directly at said balustrade end of said forward balustrade section behind said opening.

28. The passenger conveyor device according to claim 23, wherein said guide element or said further guide element has a form of a U-shaped hoop.

29. The passenger conveyor device according to claim 14, wherein said conveyor belt has curved and straight track sections and said opening is arranged in a straight track section.

30. The passenger conveyor device according to claim 14, which comprises a further balustrade on a side of said conveyor belt opposite said balustrade sections, and a handrail guided along an upper edge of said further balustrade.

31. The passenger conveyor device according to claim 14, wherein said conveyor belt is arranged at an elevated level and a platform is arranged along said opening and at the same elevation level as said conveyor belt.

32. The passenger conveyor device according to claim 31, wherein said conveyor belt is supported on a base and said platform lies at the same elevation level as said base.

33. The passenger conveyor device according to claim 14, further comprising a handrail arranged on at least one of said balustrade sections between which said opening is arranged.
